(19) United States
(12) Patent Application Publication
(10) Pub. No.: US 2017/0076352 A1
(43) Pub. Date: Mar. 16, 2017

(54) PEER-TO-PEER ITEM SHARING THROUGH PERSONAL VIRTUAL SHOPPING CARTS

(71) Applicant: ARCADIER PTE LTD, Singapore (SG)

(72) Inventors: DINUKE PRASANNA MATTHEW RANASINGHE, Singapore (SG); PAUL JOHN CASCUN, New South Wales (AU); KENNETH LOW KWOK SHION, Singapore (SG)

(73) Assignee: ARCADIER PTE LTD, Singapore (SG)

(21) Appl. No.: 15/111,298

(22) PCT Filed: Jan. 14, 2014
(86) PCT No.: PCT/SG2014/000007

§ 371 Date: Jul. 13, 2016

(51) Int. Cl. G06Q 30/06; G06Q 30/02

(52) U.S. Cl. CPC G06Q 30/0631; G06Q 30/0222; G06Q 30/0605; G06Q 30/0635

(57) ABSTRACT

This invention relates generally to electronic commerce, and more specifically to peer-to-peer item and order sharing amongst shoppers via unique personal virtual shopping carts, for the purpose of simplifying the process of obtaining feedback to assist in purchasing decision making, for recommendations for consideration for purchase, and to facilitate interaction with relevant merchants to facilitate positive sales outcomes on the whole.

### FIELD OF INVENTION

This invention relates generally to electronic commerce, and more specifically to peer-to-peer item and order sharing amongst shoppers via personal virtual shopping carts.

### BACKGROUND

Online shopping has become a common mode of shopping alongside shopping in physical stores. For shoppers, this provides not only convenience and flexibility, but also options according to individual needs.

Very often when shopping, either online or at physical stores, shoppers may discover items that they think may definitely appeal to friends and family, or in relation to which they may wish to first obtain feedback from friends and family before purchasing the said items.

Currently, in a situation where a shopper discovers items that they think may appeal to friends and family, or in relation to which they may wish to first obtain feedback from friends and family before purchasing the items, the shopper would contact their friends and family via telephone call, text message, via an instant messaging system, or email, and/or forward photographs of the item to them instantly or at a later time, which would generally then be followed by an array of message exchanges about the details of such product.

Similarly, if a shopper is requesting for feedback for an item, the current process requires the shopper to share information of the item with friends and family via telephone call, text message, via an instant messaging system, or email, and/or forward photographs of the item to them instantly or at a later time, and then collect, collate and store feedback from friends and family using communication systems not specifically designed for the purpose of gathering data-rich feedback for retail purposes.

In the recent years, many systems have been invented to facilitate effective and efficient shopping. For instance, U.S. patent application Ser. No. 12/273,955 discloses an invention to enable shopping for digital content via a virtual shopping cart. In this invention, shoppers may add a digital content item to a virtual shopping cart using a portable device.

The system in U.S. patent application Ser. No. 11/299,168 is invented to enable a shopper to add items from multiple merchants for purchase into a virtual shopping cart managed by a broker and thereafter invite other shoppers to purchase the items added into the virtual shopping cart.

In Patent Application No. PCT/US2000/029050, the invention is a website which includes an electronic shopping basket which enables several users to simultaneously access a shard shopping “basket” on a website. In U.S. patent application Ser. No. 11/506,504, a universal virtual shopping cart is invented to enable shoppers to collaborate and share information of selected shopping items in a single virtual shopping cart, in both online and physical shopping environments.

However, these current methods are neither effective nor efficient for both the shopper and the recipient(s) of the messages, in terms of retrieval of product information, details of the relevant store locations, and so forth. Sometimes, not all relevant or required information is passed on to enable the recipient to make instantaneous and remote purchases at the time the recommended item is presented to the recipient for his or her consideration. Further and as no direct relationship is created between the recipient and the merchant, the recipient is unable to easily obtain further information or to seek clarification directly from the merchant (without taking further independent steps on the recipient's own volition) before deciding whether or not to purchase the items.

This present invention is directed at overcoming or at least reducing all or some of the problems set forth above, by enabling shoppers to easily share the items discovered while shopping, and also to facilitate the direct creation of orders for the subsequent purchase.

### SUMMARY OF THE INVENTION

The present invention relates to computer-implemented methods, systems and computer programme products to enable easy sharing of items discovered during shopping by shoppers and their friends and family, for more effective and efficient shopping experiences.

In one exemplary embodiment of the present invention, a system comprises a plurality of personal virtual shopping carts associated with shopping devices used by shoppers, wherein the devices are connected to a proprietary platform, via a network. The personal virtual shopping cart enables shoppers to easily create orders of items discovered while shopping and simultaneously and easily share the items or orders with friends and family, for the purpose of obtaining feedback or for their consideration for purchase as well.

In a second exemplary embodiment of the present invention, a computer-implemented method comprises establishing personal virtual shopping carts associated with shopping devices used by shoppers, wherein the devices are connected to a proprietary platform via a network, enabling shoppers to easily create orders of items discovered while shopping and simultaneously share the items or orders with friends and family, for the purpose of obtaining feedback or for their consideration for purchase.

In a third exemplary embodiment of the present invention, a computer programme product comprises a computer readable storage medium having computer readable programme code embodied therewith. The computer readable programme code comprises computer readable programme code configured to establish a plurality of personal virtual shopping carts associated with shopping devices used by shoppers, wherein the devices are connected to a proprietary platform via a network, enabling shoppers to easily create orders of items discovered while shopping and simultaneously share the items or orders with friends and family, for the purpose of obtaining feedback or for their consideration for purchase.

The details of the present invention, both as to its structure and operation, are described below with reference to the accompanying drawings. This summary is intended to identify the key features of the present invention, but it is not intended to be used to limit the scope of the present invention.

### DETAILED DESCRIPTION

The present invention relates generally to electronic commerce. More particularly, the present invention is directed to systems, methods and computer programme products for shopping which enables sharing of items discovered during shopping among shoppers for more effective and efficient shopping experiences.

The personal virtual shopping cart being proposed is a single proprietary application that may be ubiquitously and simultaneously used across numerous merchant platforms in both digital (online) and physical (offline) environments, and in the latter situation via numerous vectors of entry.

The personal virtual shopping cart may be presented within an application or through a web browser in a shopping device, which is connected to and interfaces with a proprietary platform through a network. The shopping device may be any smart device, which are devices that can operate interactively and autonomously and which may connect to and interface with the proprietary platform. For example, smart phones, tablets, computers, smart television, and so forth.

The proprietary platform to which the personal virtual shopping cart is connected consists of a three-tiered architecture of client-business logic server databases that are protected by a firewall for security. The business logic servers are predominantly web servers coded with business logic as well as other business logic encoding nodes which include hardware connectivity to external systems, execution devices to process data and abstraction tools to parse the information being handled. The database servers could be any node optimised for handling volume data and performing logic data extraction queries. The three tiers of the proprietary platform can be composed of heterogeneous elements both within and across the three tiers. As such, a population of dissimilar shopping devices can communicate with a datacentre of dissimilar servers that store their data on dissimilar database servers. What is common is the communication that occurs between the tiers. For example, any of the shoppers' devices can communicate with the server via TCP/IP and other Internet based protocols, some of which are proprietary, for the signalling required for the purpose of application activity. Further, the communication between the logic servers and the database servers is performed predominantly in SQL and other semaphore based communication styles. Both shopper/server and server/database communication is bi-directional. When shoppers and merchants interact with the proprietary platform via the shoppers' devices, the server adheres to the pre-defined business processes and thereafter retrieves and checks against information from the database server. The system uses but is not restricted to Android, iOS, QNX, Unix variants and Windows operating systems, or Microsoft SQL, android native, iOS native databases or Android, iOS, windows and unix file systems.

Shoppers' devices may be connected to the platform through any computer or data network which allows computing devices to communicate via data connections. These networks could be cable networks, wireless networks or any other signalling media.

The personal virtual shopping cart is used by shoppers to keep track of selected shopping items, retrieve and access relevant information of the selected shopping items such as pricing, product descriptions, store locations, marketing information and so forth as well as to purchase the selected shopping items. A shopper may enter shopping items from any participating merchant who are connected to the proprietary platform. Participating merchants may connect to the proprietary platform via the merchants' existing proprietary systems or other proprietary network systems which the merchants subscribed to in order to manage and sell their items. Alternatively, a participating merchant may manually upload their information or their inventory into the proprietary platform, for shoppers' access.

A shopper may enter shopping items of participating merchants found digitally or even physically, including items in online or physical stores as well as items as set out in the participating merchants' physical printed marketing materials such as on billboards, magazines, newspapers and so forth, or conversely in digital marketing media such as web advertising, electronic direct mail, and so forth.

Selected items from multiple merchants, in both digital and physical environments, may be entered into a personal virtual shopping cart through various and multiple vectors of entry, including but not limited to barcodes, Quick Response (“QR”) codes, image scanning, Near Field Communication (“NFC”), Bluetooth (Low Energy) (“BLE”), Digital (Web and mobile) clicks, sound waves and white noise, biometrics, in-app selection and so forth. For example, a barcode is an optical machine-readable representation of data relating to the shopping item to which it is linked, on both digital and physical interfaces. The barcode enables an information transfer for the item tagged with the barcode. For items which are tagged with a barcode, a shopper may then use a shopping device such as a smart phone in which the personal virtual shopping cart application is operating, to scan the barcode on the item which will then download information of the item and thereby “enter” the item's details into the personal virtual shopping cart.

Upon the entry of an item into a personal virtual shopping cart, an actual order of the item of interest in the shopper's personal virtual shopping cart is created. At this time, the shopper develops a direct relationship with the merchant of the items and may directly engage the merchant to eventually purchase the item in the order (directly from the merchant), or the shopper may wish to first solicit additional information from the merchant to assist the shopper in his or her decision-making.

Once an item is entered into a personal virtual shopping cart and an order is created therein, the order remains in the personal virtual shopping cart until the shopper proceeds to purchase the items in the order or deletes the order from the personal virtual shopping cart. For so long as the order remains in a personal virtual shopping cart, in the information of the items in the order, for instance product availability, pricing, promotions and so forth, as reflected in the personal virtual shopping cart will be updated in real time and the shopper would be prompted and notified of such changes accordingly.

Should the shopper decide to proceed to purchase the items in the order, the shopper can then send instructions to the payment processor for authorisation, through the platform. Payment authorisation can take various forms and will depend on the payment processor's proprietary authorisation flows, as well as respective card scheme, bank and regulatory requirements or any other existing and relevant financial services legislation. Parts of the authorisation process flow may reside on the proprietary platform, as required by the payment processor to enable the authorisation of the payment.

If the shopper wishes to first obtain feedback from friends and family before purchasing the item, the shopper may then share the intended order by sending the said order from the shopper's personal virtual shopping cart to the personal virtual shopping cart of a single recipient, or to a group of recipients. The shopper may retrieve and select the contact details, such as phone number, email address or other usable user identification of friends and family (also known as a “contact”) from the contact list in the shopping device, and thereby have the order sent to the selected recipient's personal virtual shopping cart. When sending or placing the order into a contact's personal virtual shopping cart, the shopper may include a personal message to the recipient or contact. The accompanying message may be written (example via email, SMS text, instant message, and so forth), or it may consist of a voice message, photograph or video. There is no limit to the number of individuals to which a shopper can send and share an order with, nor is there a limit to the number of times a shopper will be able to send the same order to other shoppers. In addition, the shopper can send and share the order with other shoppers regardless of whether or not an intended order was actually proceeded with by the shopper (in other words, whether or not the shopper actually made the purchase subsequently).

When an order is shared with a recipient, the shopper's order will be replicated in the recipient's personal virtual shopping cart and the recipient will receive a notification that an order has been shared along with a brief description of the shared order, for example there might be a request for feedback.

Upon receipt of an order (perhaps with a request for feedback) in the recipient's personal virtual shopping cart, the recipient may provide feedback or comments to the shopper by sending the feedback or comments to the shopper via the shopper's personal virtual shopping cart. The shopper is then able to collect and collate all the information and feedback in a single application, i.e. through the shopper's unique personal virtual shopping cart.

Similarly, if a shopper believes that an item discovered may also appeal to specific friends or family members, the shopper may send the intended order in the shopper's personal virtual shopping cart to and have it replicated in the personal virtual shopping carts of these friends and family members, for their consideration for their own purchase if so desired.

Upon receipt of an intended order, the recipient(s) would also be able to retrieve from the proprietary platform all the relevant information uploaded onto and made available on the proprietary platform by the merchant of the item, and have the information reflected in the recipient's personal virtual shopping cart, for easy reference. The recipient then has the choice of whether or not to accept or reject the order.

When an order is accepted by the recipient, an actual order replicating the order in the shopper's order is created in the personal virtual shopping cart of the recipient. The recipient thereby develops a direct relationship with the merchant of the items or orders. The recipient may directly engage the merchant to purchase the item in the order (directly from the merchant), immediately or at a later time more convenient to the recipient. The recipient may also directly engage the merchant to solicit additional information to assist in his or her decision-making.

Additionally, when a merchant is notified of the acceptance of an order from a merchant's store or advertisement sent and entered into personal virtual shopping carts, the merchant is able to engage directly the referred shoppers. The merchant may also attempt to influence and convert the orders into sales by providing individual shoppers with personalised incentives to purchase. Similarly, the recipient of a feedback request may also be directly engaged to consider purchasing the item as well. This invention facilitates peer-to-peer sharing of items and orders, and also encourages sales for merchants, creating a recursive process and thereby encourages positive sales outcomes for merchants. As can be imagined, the potential commercial benefits and advantages to merchants and business owners are significant.

In another aspect of the present invention, a shopper may send an order to the personal virtual shopping cart of another for the other person to make the purchase on their behalf. For instance, if the shopper is a child or minor who may not have the legal or financial ability to purchase, the child may enter the item of interest into the child's personal virtual shopping cart, and subsequently send and share the order comprising of the item of interest along with all the relevant information over to the child's parents or guardians via their personal virtual shopping carts, for the parents or guardians to complete the purchase.

In another aspect of the present invention, group orders may be collated for a single purchase. For instance, a group of friends shopping together may want to collate all their orders into an individual's personal virtual shopping cart, for a single purchase of all the items by only one person. This is beneficial because a consolidated purchase will usually result in costs savings, either as a result of preferential prices being offered by the merchants for bulk purchases and/or by savings in the cost of transport of these bulk purchases.

Due to the invention's ease of use and efficient manner and mode of transmission of shopping information, a viral effect would result from an initial order. This allows a merchant to reach numerous users of the invention, on a global basis. Another aspect of the invention would therefore be for advertisements or opportunities for sponsorships to be also offered to merchants, and incorporated into the invention.

The present invention has been described in terms of specific implementations and configurations which are intended to be exemplary only. The illustrative embodiments of the present invention as described above do not describe all features of the actual implementation. Those skilled in the art, having read this disclosure will appreciate that numerous implementation-specific decision must be made in the development of an actual embodiment, many obvious variations, refinements and modifications may thus be made without departing from the inventive concept(s) disclosed herein.

### BRIEF DESCRIPTION OF THE DRAWINGS

The invention may be understood by reference to the following description and appended claims, when taken in conjunction with the accompanying drawing, in which:

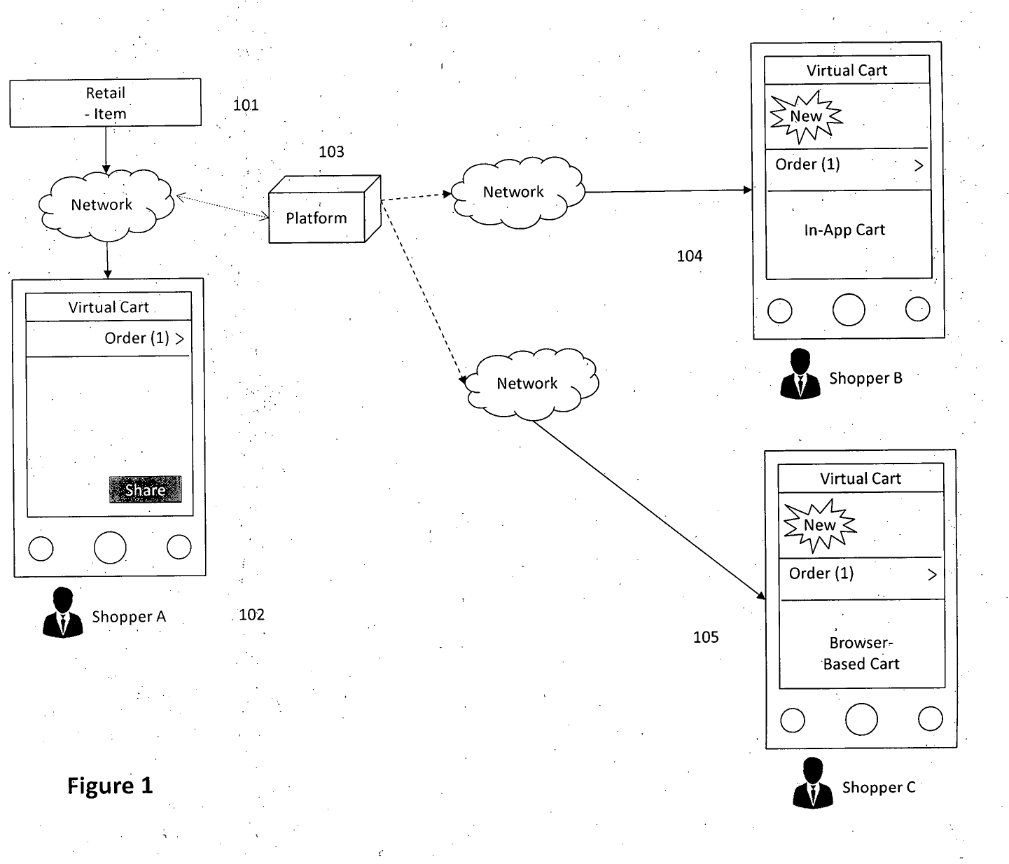

FIG. 1 illustrates an example of the functioning of the present invention wherein peer-to-peer item and order sharing is performed. In this illustration, Shopper A went shopping at a physical retail store 101 and selects an item. Shopper A adds the selected item into Shopper A's personal virtual shopping cart 102 by scanning the item using Shopper A's shopping device which is connected to platform 103 via a network. Platform 103 then creates an order (which may include information of the merchant or retailer, details of the item, product pricing, availability and so forth) which is reflected in Shopper A's personal virtual shopping cart 102. Shopper A then decides to share, recommend or send this item to Shopper B and Shopper C. Shopper A may select Shopper B and Shopper C from the existing contact list or manually input details of Shopper B and Shopper C such as their mobile numbers, email addresses or other accessible user identities and sends the order to Shopper B's personal virtual shopping cart 104 and Shopper C's personal virtual shopping cart 105 via the Platform 103. There is no limit to the number of individuals to which Shopper A can send and share the order to and the number of times Shopper A will be able to send the same order to other shoppers. In addition, Shopper A can send and share the order with other Shoppers regardless of whether or not the order was purchased by Shopper A. In this instance, two outcomes may then occur;
a. Shopper B receives a notification that an order is delivered to Shopper B's personal virtual shopping cart 104 from a contact, and upon seeing the details of the order decides to keep the order. Shopper B may then immediately purchase the items (or a subset or portion thereof) within the order, or forward the order to another Shopper, for their consideration to purchase or for their feedback, or purchase and pay for the order at a later time.
b. Shopper B receives a notification that an order is delivered to Shopper B's personal virtual shopping cart 104 from a contact, and upon seeing the details of the order decides to delete the order.

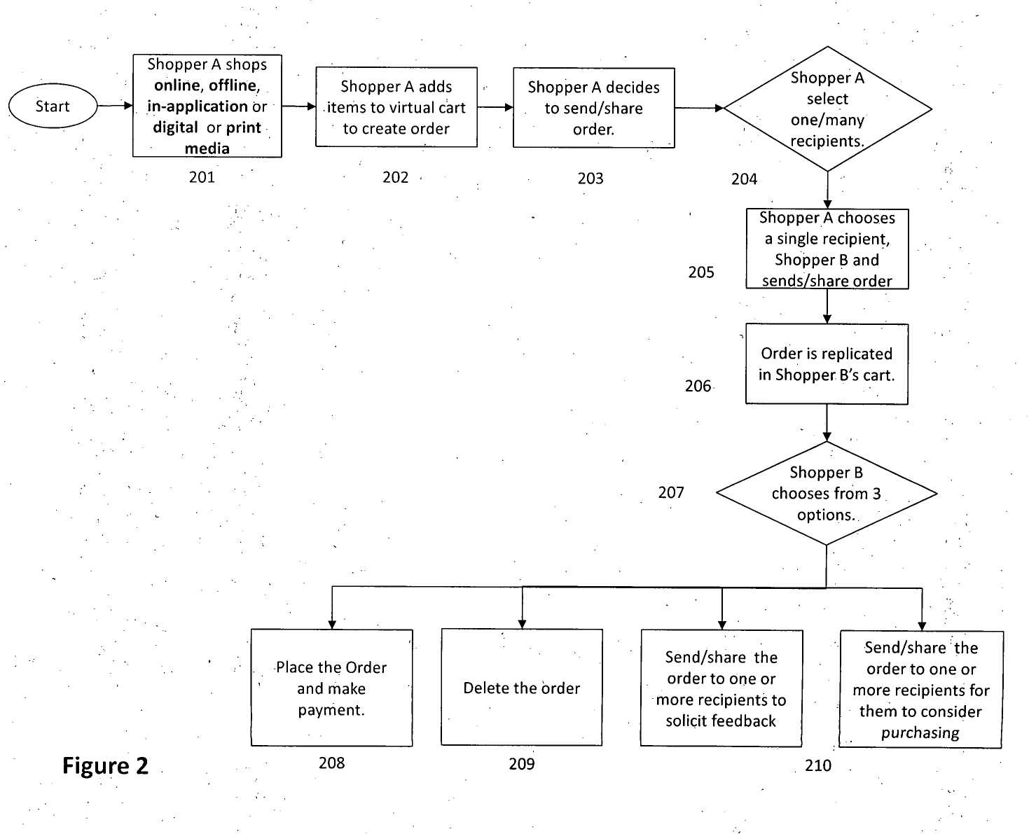

FIG. 2 is a flow chart illustrating the process flow of the present invention wherein peer-to-peer item and order sharing is performed. Shopper A may be shopping online or at a physical store or via electronic or print media or through any other means and via any medium where items are offered for sale 201. Shopper A finds something of interest, and adds the item into Shopper A's personal virtual shopping cart and thereby creating an order 202. Shopper A thinks that the item may also appeal to others and decides to send and share the order 203. Shopper A may select one or more recipients or a pre-defined group of recipients 204. In this example, Shopper A decides to send and share the order with only a single recipient, Shopper B. Shopper A then sends and shares the order with Shopper B through Shopper B's personal virtual shopping cart. The order is received and replicated in Shopper B's personal virtual shopping cart 206. Once Shopper B has the order in Shopper B's personal virtual shopping cart, Shopper B may choose from three options 207, as follows:
a. Purchase and make payment for the order immediately 208;
b. Delete the order from Shopper B's personal virtual shopping cart 209;
c. Share and send the same order to one or more of Shopper B's contacts 210 for the purposes of soliciting feedback or to recommend the order for the recipient's consideration for purchase.

1. A new and innovative system for electronic commerce, comprising:
a plurality of shopping devices;
computer readable storage platform having computer readable programme code embodied;
computer readable programme code configured to establish a plurality of personal virtual shopping carts connected by a network;
network consists of application programming interfaces (APIs) connecting multiple merchants via a single virtual shopping cart;
peer-to-peer sharing of items and creation of orders amongst shoppers to obtain feedback or for recommendation for consideration.

2. A system according to claim 1, wherein the shopping device may be any smart device which can operate interactively and autonomously, and which may connect to and interface with the platform.

3. A system according to claim 2, wherein an order may be created in a digital or physical environment, including but not limited to various medium or vectors of entry.

4. A system according to claim 3, wherein the peer-to-peer sharing further comprises the input of an item into a personal virtual shopping cart thus creating an order for the item.

5. A system according to claim 4, wherein the order may be sent to selected recipient's personal virtual shopping cart along with a request for feedback, and the recipient of a request for feedback may in turn provide feedback to the sender by sending the feedback to the sender's personal virtual shopping cart.

6. A system according to claim 5, wherein an order placed in a recipient's personal virtual shopping cart is an actual order replicated from the order in the sender's personal virtual shopping cart, whereby the recipient may then accept and proceed to purchase the item or items, or hold the order, or reject and delete the order from the recipient's personal virtual shopping cart.

7. A system according to claim 6, wherein the feedback provided by various users may be collected and collated in the sender's personal virtual shopping cart together with all the information relating to the order.

8. A system according to claim 7, wherein upon being notified of the acceptance of an order from a merchant's store or advertisement sent and placed in a shopper's personal virtual shopping cart, the merchant may engage the referred shoppers directly and provide incentives to try to convert the order into a positive sale.

9. A computer-implemented method for sharing of items, comprising:
the use of a plurality of personal virtual shopping carts through an application or a computer based browser on advanced communication devices connected to a platform via a network;
the location and subsequent sharing of items of interest while shopping in both online (digital) and offline (physical) environments;
the input of selected items discovered while shopping into the personal virtual shopping carts through numerous vectors of data entry;
the creation of an order in the personal virtual shopping cart and retrieving information of the selected items from the platform to which the smart devices are connected;
the selection whether automatic or manually from a contact list in the said communication or shopping device, or manually inputting the contact details of an intended recipient of the order;
the sending of a personal message together with the order;
the receiving of the order with all the relevant information and the personal message by a recipient;
the recipient accepting or ignoring or deleting the orders entered into the personal virtual shopping cart.

10. A method according to claim 9, wherein the shopping device may be any smart device that can operate interactively or autonomously interfaces, and which may connect to and interface with the platform.

11. A method according to claim 10, wherein an order may be created in a digital or physical environment, including but not limited to various medium or vectors of entry.

12. A method according to claim 11, wherein the peer-to-peer sharing further comprises the input of an item into a personal virtual shopping cart thus creating an order of the item.

13. A method according to claim 12, wherein the orders created in the personal virtual shopping carts are actual orders, which the shoppers may proceed to purchase, directly from the merchants of the items referred to in the said orders.

14. A method according to claim 13, wherein the items entered into the personal virtual shopping carts may be from several unrelated and distinct merchants.

15. A method according to claim 14, wherein upon entering of the items into a personal virtual shopping cart and creating orders therein, all relevant information of the items as made available by the merchant of the items may be retrieved from the platform to which the smart device is connected and may be then perused in the personal virtual shopping cart.

16. A method according to claim 15, wherein an order will remain in the personal virtual shopping cart until a shopper proceeds to purchase the items in the order or deletes the order from the personal virtual shopping cart.

17. A method according to claim 16, wherein information of the items in an order, as reflected in the personal virtual shopping cart will be updated in real time and the shopper would be prompted and notified of such changes accordingly.

18. A method according to claim 17, wherein an order may be sent to selected recipient's personal virtual shopping cart along with a request for feedback, and the recipient of a request for feedback may in turn provide feedback to the sender by sending the feedback to the sender's personal virtual shopping cart.

19. A method according to claim 18, wherein the sender or a recipient of an order is not restricted from and may create and share orders with one or more recipients or a group of recipients at the same time or at different times, via the personal virtual shopping cart.

20. A method according to claim 19, wherein the feedback provided by various users may be collected and collated in the sender's personal virtual shopping cart together with all the information relating to the Order.

21. A method according to claim 20, wherein an order placed in a recipient's personal virtual shopping cart is an actual order replicated from the order in the sender's personal virtual shopping cart, whereby the recipient may then accept and proceed to purchase or hold the order, or reject and delete the order from the recipient's personal virtual shopping cart.

22. A method according to claim 21, wherein upon being notified of the acceptance of an order from a merchant's store or advertisement sent and placed in a shopper's personal virtual shopping cart, the merchant may engage the referred shoppers directly and provide incentives to try to convert the order into a positive sale.

23. A computer programme product comprising a computer readable storage medium having computer readable programme code embodied therewith, the computer readable programme code comprising:
computer readable programme code configured to establish a plurality of personal virtual shopping carts associated with shopping devices used by shoppers, wherein the devices are connected by a network;
computer readable programme code configured to enable the sharing of items of interest amongst shoppers via orders created in personal virtual shopping carts, for the purposes of obtaining feedback or for recommendation for consideration for purchase.

24. A computer programme product of claim 23, wherein the personal virtual shopping cart may be presented within an application or through a web browser on any device which can operate interactively and autonomously, and which is connected to the proprietary platform.
